(19) United States
(12) Patent Application Publication
(10) Pub. No.: US 2001/0001409 A1
(43) Pub. Date: May 24, 2001

(54) METHOD AND APPARATUS FOR FORMING COMPOSITE HONEYCOMB CORE

(76) Inventors: TERRY WEIGHT, PLEASANTON, CA (US); DOUGLAS L. MCLARTY, SAN FRANCISCO, CA (US); MITCHELL MEHLMAN, PLEASANTON, CA (US)

Correspondence Address: J E KOSINSKI, LORAL SPACE & COMMUNICATIONS LTD, 655 DEEP VALLEY DRIVE, SUITE 303, ROLLING HILLS ESTATES, CA, 90274

(21) Appl. No.: 09/327,815

(22) Filed: Jun. 8, 1999

(51) Int. Cl. B31F 1/00

(52) U.S. Cl. 156/197; 156/200

(57) ABSTRACT

An assembly of mold elements for constructing honeycomb core material comprising: a holding plate with semi-hexagonal corrugations; a series of individual hexagonal mandrels, and a forming roller having semi-hexagonal lobes. Said mold elements being used, in sequence, to form composite sheets into bonded cellular honeycomb core material.

### BACKGROUND OF THE INVENTION

Wherever there is a need for light weight, rigid, construction material, a sandwich panel may be considered. Such panels are constructed with a core comprised of corrugated layers which form hollow cells. The core is generally contained within rigid exterior panels. The corrugated layers are made of a light weight material such as aluminum which are stamped and welded together to form the cells. The cells can extend parallel or transverse to the exterior panels. In this manner extremely strong light weight structural panels may be formed. These panels may be used in aircraft wing and body components, the skin of spacecraft, antennae reflectors and many other uses. The cells can be used as passages for cooling and other purposes which make the sandwich panels even more adaptable.

As sandwich material structural panels have gained in popularity, the materials from which they are constructed have diversified. It is a purpose of this invention to provide a core constructed of composite materials, in particular material constructed of structural fibers in an organic resin core.

### SUMMARY OF THE INVENTION

Pliable sheets of organic matrix reinforced with structural fibers are hand laid up on a rectangular form. The form is a generally flat surface having a series of parallel undulations. Each undulation, either peak or valley, is constructed with a semi-hexagonal cross section. Multiple layers of composite matrix sheets are arranged to conform to the undulating shape of the forms with the top of the undulation of the composite sheet of one layer engaging the bottom of the undulation of the adjacent sheet to provide bonding of one sheet layer to the other during curing of the composite core formed thereby.

The starting layer of the form consists of a flat continuous holding panel having the hexagonal undulations described above. A first composite sheet is applied to the holding panel and is formed to the panel contour by the application of an elongated roller. The roller is of generally cylindrical shape and has a series of lobes extending outward from its circumference to form a gear shaped cross section. Each lobe of the gear is of semi-hexagonal cross section to fully engage the undulations of the holding panel as the roller is rotated over the composite sheet, thereby forming the sheet to the shape of the holding panel.

To construct the form for subsequent layers, a series of elongated mandrels are used. The mandrels are shaped as rods having hexagonal cross sections which match the cross section of the holding panel. The mandrels are positioned in the depressed portions of the undulations of the first layer. The exposed portion of each mandrel extends above the adjacent surface and forms an undulating surface having the desired semi-hexagonal cross section. In addition the upper portion of the composite sheet is exposed on either side of the exposed portion of the mandrel to provide access thereto for subsequent layers. A second layer of composite sheet may then be applied to the form and rolled as before. In this manner multiple layers of composite cellular core can be formed as needed.

The body of each mandrel is constructed of aluminum and then coated with nickel impregnated with a non stick agent such as TEFLON, available from Dupont. This allows a quick release of the mandrels from the completed core and avoids the use of mold agents which tend to contaminate the core surface and may require extensive cleaning.

### DESCRIPTION OF THE DRAWING

The invention of this application is described in more detail below with reference to the Drawing in which:

FIG. 1 is an enlarged end view of the forming assembly of this invention;

FIG. 2 is an end view of the layer forming roller of this invention;

FIG. 3a is a perspective view of the curing rack assembly of this invention;

FIG. 3b is a perspective view of the detail 3b of FIG. 3a;

FIG. 4a is a side view of the mandrel of this invention; and

FIG. 4b is an end view of the mandrel of this invention.

### DESCRIPTION OF THE PREFERRED EMBODIMENT

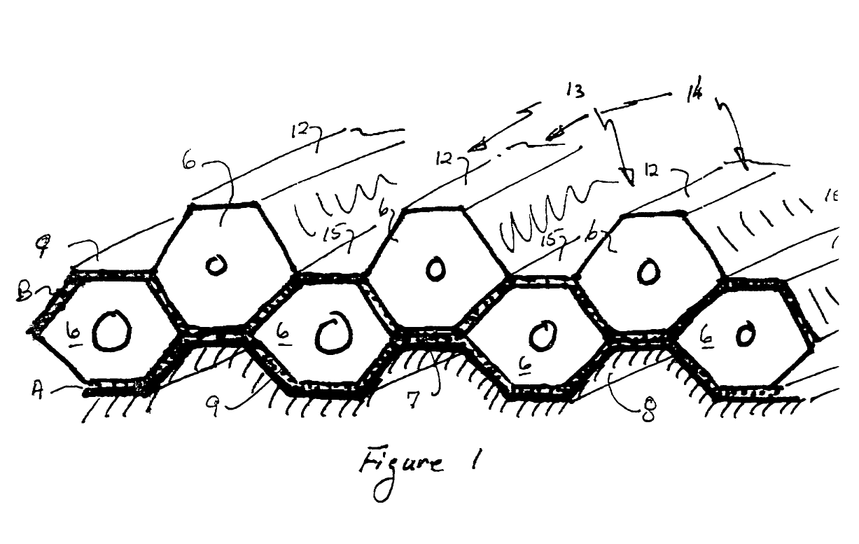

Two layers of a material assembled for curing is shown in FIG. 1. The core consists of pliable sheets 9 of a structural fiber reinforced organic matrix material formed about a series of mandrels 6 supported by a holding panel 8. The sheets 9 engage at sections 7 to form bonding surfaces during curing. With the withdrawal of the mandrels 6 an open cell is formed. Although for illustration, only one layer is shown, the honeycomb core can be constructed of multiple layers depending on the application.

Mandrels 6, as shown in FIGS. 4a and 4b, are rigid rods constructed of aluminum and machined with a series of flats to form a hexagonal cross section. The dimensions of the cross section are predetermined in accordance with the desired density of the honeycomb core. In prior art, mold elements such as mandrels, are surface coated with a mold release agent to facilitate the removal of the mold element after the product is formed. These mold release agents create environmental concerns and can contaminate the finished product. To avoid the need for the use of such agents, the aluminum rods are treated to form a permanent outer surface of a nickel based PTFE impregnated material. This creates a hard, durable surface which allows the mandrel 6 to be easily removed from the cured honeycomb core, after the curing process is complete.

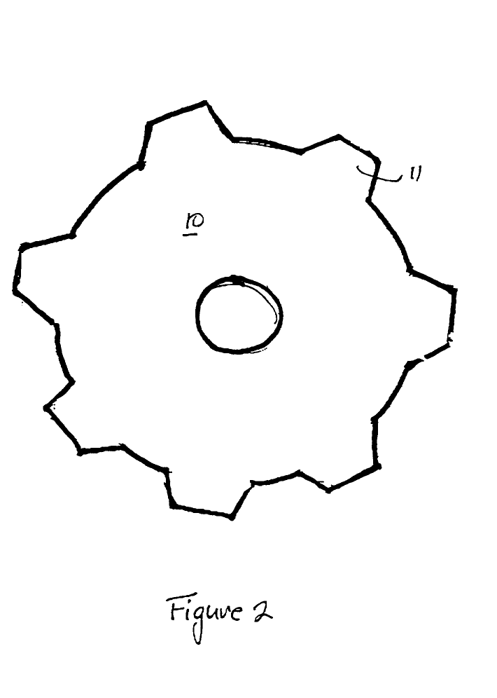

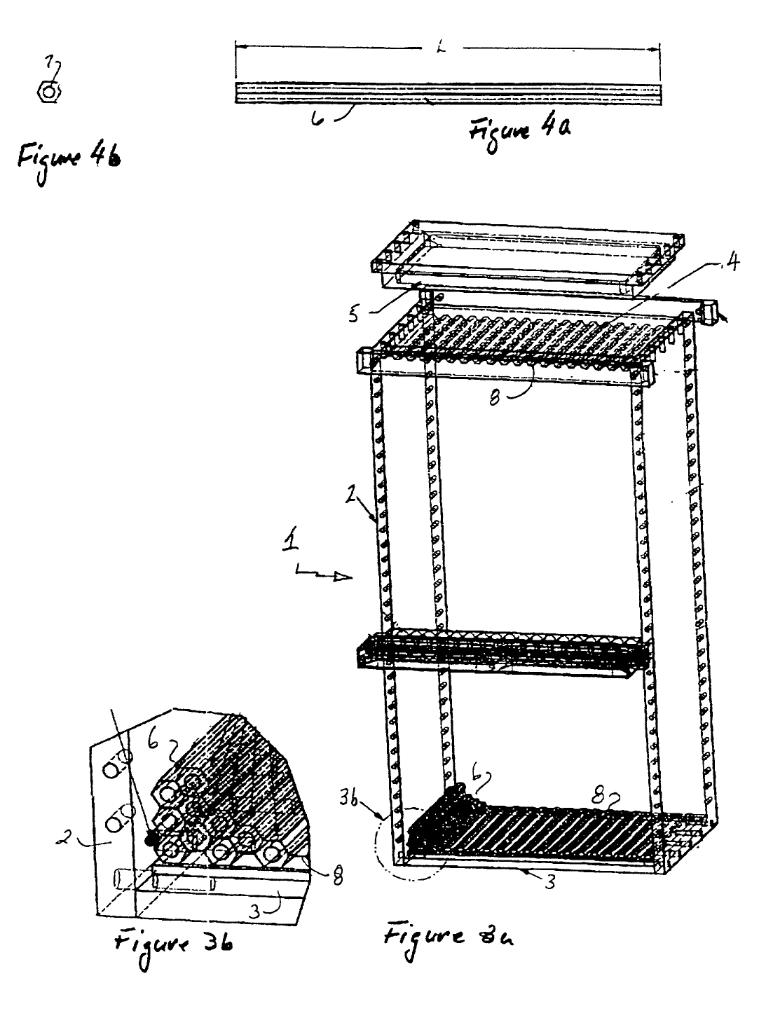

To initiate the layering of successive sheets of composite material, while constructing the form for molding the cellular core, a holding panel 8 is constructed of an aluminum sheet having undulating corrugations as shown in FIGS. 1, 3a and 3b. Each of the undulations consists of grooves 13 and ridges 14 which extend the width of the panel 8. The grooves 13 and ridges 14 are merely sinusoidal images of each other and have a semi-hexagonal cross section consistent with the hexagonal cross section of the mandrels 6. The surface of holding panel 8 supports a first layer of the composite material and begins the assembly of mold elements which are held by the curing rack 1.

Curing rack 1 consists of side supports 2, a base member 3, and a top member 5 assembled to support multiple layers of the combined composite core and the mold elements. The purpose of the rack 1 is to support the core and mold elements while the composite core is hardened, through curing under heat and pressure. As is shown in FIG. 3a, a pair of holding panels 4 and 8 are used at the top and bottom of the mold assembly. In order to make a honeycomb core of reasonable density of an approximate size of one foot by two foot by eight inches, an assembly of over 2000 mandrels would be required. The lay up process is therefore a considerable task. In order to prevent bridging of the composite sheet over portions of its mold form, a cylindrical roller 10 is constructed having gear shaped lobes 11 extending outward from its periphery. The lobes 11 are sized to engage the grooves 13 and ridges 14 of the underlying mold form. In order to force a close engagement of the uncured composite sheet into the mold form, the roller 10 is positioned into engagement with a groove 13 and then rotated over the form.

Except for the initial layer in which the holding panel comprises the mold form, subsequent layers are laid up over a mold form constructed by positioning a series of mandrels 6 in the grooves 13.

It can be observed from an examination of FIG. 1, that as the mandrels 6 are positioned the composite sheet 9 takes on the undulating shape of the ridges and grooves formed by the mandrels 6. The active surface of the mold form of each subsequent layer consists of the upper mandrel surface 12 and the upper surface of the composite sheet 15. The next layer therefore directly engages a defined section of the positioned adjacent composite sheet 9. During curing, this junction will form a bond and give structural integrity to the honeycomb core.

Since the coefficients of expansion of the mandrels 6 and the cured composite core are different and since the mandrels 6 are treated, the mandrels 6 may be easily removed from the core as a final step in the forming process.

In operation, the mold apparatus is used by installing a holding panel 8 having the desired cross section to generate a particular cell density within the composite core. A sheet (A) of structural fiber reinforced organic matrix composite 9 is laid over the holding panel 8 and the forming roller 10 is engaged and rolled over the composite sheet 9. This stretches the sheet (A) into interim conformity with the alternating grooves 13 and ridges 14. After the rolling operation is complete, a series of mandrels 6 are aligned within the grooves 13 having their similar cross sections fully engaged. A secondary mold form is thereby generated as a composite of the top surface 12 of the mandrel 6 and the top surface 15 of a ridge 14. The ridge 14 is covered by the first layer of the composite sheet 9.

A second composite sheet (B) is applied to the secondary mold form thus generated and the roller 10 is used to insure full engagement of the composite sheet (B) with the contour of the mold form. The process may then be repeated until the desired depth of the core is obtained. The curing rack 1 is then placed in an oven or autoclave where the composite sheets 9 are cured under heat and pressure. The assembly is removed and allowed to cool. Since the composite core will cure in an expanded state and the cooled mandrels will shrink as they cool, the mandrels 6 will easily disengage. The composite core may be immediately processed for further fabrication without the need to remove contaminants such as mold release agents.

We claim:

1. Apparatus for forming honeycomb core structures, said structures being constructed of layered sheets of composite material molded to define open cells extending parallel and having a predetermined length, said apparatus comprising:
a holding panel constructed with a series of parallel ridges and grooves extending the predetermined length, said ridges and grooves having identical semi-hexagonal cross sections and being arranged in a sinusoidal relation to present a first forming surface, wherein the holding panel supports a first layer of composite sheet material;
a plurality of mandrels each constructed in the form of an elongated rigid rod of the predetermined length, and having a hexagonal cross section which matches the cross section of the grooves and ridges of the holding panel, wherein said mandrels are positioned, in at least one layer, on top of the first layer of composite sheet within the grooves of the holding panel to generate a second forming surface similar to said first forming surface; and
an interim forming roller having a generally cylindrical shape and the predetermined length, said roller being constructed with a plurality of longitudinally extending lobes, said lobes having semi-hexagonal cross sections sized to engage the grooves and ridges of the forming surfaces as the forming roller is rotated across said forming surfaces, wherein the interim forming roller positions the layers of composite sheet material in conformity with the ridges and grooves of the forming surfaces.

2. Apparatus for forming honeycomb core structures, said structures being constructed of layered sheets of composite material molded to define open cells extending parallel and having a predetermined length, said apparatus as described in claim 1 wherein the mandrels are constructed of a rigid aluminum rod which has a nickel based outer shell impregnated with a non stick material.

3. A method of forming honeycomb core structures, said structures being constructed of layered sheets of composite material molded to define open cells extending parallel and having a predetermined length, said method comprising the steps of:
i) constructing a first mold surface having a series of parallel ridges and grooves extending the predetermined length, said ridges and grooves having identical semi-hexagonal cross sections and being arranged in a sinusoidal relation;
ii) applying a first sheet of moldable composite material on said first mold surface;
iii) constructing an interim forming element for sequential engagement with the ridges and grooves of said first forming surface to further position the first sheet of moldable composite material in conformity with the contour of said ridges and grooves of said first forming surface;
iv) constructing a second mold surface by positioning a plurality of mandrels constructed in the form of an elongated rigid rod of the predetermined length, and having a hexagonal cross section which matches the cross section of said grooves and ridges of the first forming surface, wherein said mandrels are positioned on top of the first layer of composite sheet within the grooves of the first forming surface to generate a second forming surface similar in shape to said first forming surface;
v) applying a second sheet of moldable composite material on said second mold surface;
vi) sequentially engaging the interim forming element with the ridges and grooves of said second forming surface to further position the second sheet of moldable composite material in conformity with the contour of said ridges and grooves of said second forming surface;
vii) repeating steps iv through vi to build up a predetermined number of layers;
viii) curing said layers of composite material under heat and pressure to form the cellular honeycomb core; and
ix) removing said mandrels from the cured honeycomb core.

4. A method of forming honeycomb core structures, said structures being constructed of layered sheets of composite material molded to define open cells extending parallel and having a predetermined length, said method as described in claim 3 wherein said step of constructing an interim forming element for sequential engagement with the ridges and grooves comprises constructing an interim forming roller having a generally cylindrical shape and the predetermined length, said roller being constructed with a plurality of longitudinally extending lobes, said lobes having semi-hexagonal cross sections sized to engage the grooves and ridges of the forming surfaces as the forming roller is rotated across said forming surfaces, wherein the interim forming roller positions the layers of composite sheet material in conformity with the ridges and grooves of the forming surfaces.

5. A method of forming honeycomb core structures, said structures being constructed of layered sheets of composite material molded to define open cells extending parallel and having a predetermined length, said method as described in claim 3 wherein said step of constructing a second mold surface by positioning a plurality of mandrels further comprises constructing said mandrels of a rigid aluminum rod which has a nickel based outer shell impregnated with a non stick material.
